(19) United States
(12) Patent Application Publication
(10) Pub. No.: US 2023/0399539 A1
(43) Pub. Date: Dec. 14, 2023

(54) ONE-COMPONENT SYSTEM COMPRISING BLOCKED POLYURETHANE PREPOLYMERS

(71) Applicant: Evonik Operations GmbH, Essen (DE)

(72) Inventors: Denis Pukrop, Dülmen (DE); Christoph Nacke, Schermbeck (DE); Silvia Herda, Herne (DE); Emmanouil Spyrou, Schermbeck (DE); Guido Streukens, Wuppertal (DE)

(21) Appl. No.: 18/331,731

(22) Filed: Jun. 8, 2023

(30) Foreign Application Priority Data
Jun. 8, 2022 (EP) 22177717.0

(51) Int. Cl. C09D 175/08; C08G 18/82; C08G 18/83

(52) U.S. Cl. CPC C09D 175/08; C08G 18/82; C08G 18/831

(57) ABSTRACT

The present invention relates to a one-component system comprising
a) at least one polyurethane prepolymer based on at least one di- and/or polyisocyanate and at least one di- and/or polyol, wherein at least one di- or polyol is a polyalkylene glycol having a number-average molecular weight of 900 to 2150 g/mol, wherein all unconverted isocyanate groups are blocked with at least one malonic ester and
b) at least one di and/or polyamine;
   to a process for its production, to its use and to processes employing it for producing artificial leather and (artificial) leather coatings.

### FIELD OF THE INVENTION

The present invention relates to a one-component system which may be used for producing artificial leathers and (artificial) leather coatings and to a process for production thereof. The invention further relates to the use of the one-component system for producing artificial leathers or (artificial) leather coatings and to the process for producing an artificial leather or an (artificial) leather coating.

### BACKGROUND

Artificial leathers are textiles and other flexible sheetlike articles produced using plastics with or without an outer layer which have partly leather-like properties and/or a surface configuration (for example embossing) corresponding to the intended use. The term “artificial leather” is in particular to be understood as meaning leather-like materials comprising at least one carrier layer (for example made of paper, cotton or plastic, in particular polyester) and at least one planarly attached (for example applied) plastics coating.

By contrast “(artificial) leather coatings” are plastics coatings that may be applied either to natural leather or to artificial leather to achieve particular properties typical of artificial leather.

### DETAILED DESCRIPTION

It has recently been found that plastics based on polyurethane prepolymers that are crosslinked with at least difunctional alcohols and/or amines result in particularly advantageous properties of the artificial leather and (artificial) leather coatings resulting therefrom. Polyurethane prepolymers are to be understood as meaning oligomeric or polymeric isocyanate-terminated reaction products which have at least one urethane bond and are producible from a deficit of polyol and an excess of di- or polyisocyanates. Since pure polyurethane prepolymers produced from di- or polyisocyanate and polyol component would react with the recited crosslinkers even at room temperature, they must be stored in separate receptacles. The associated technology is therefore referred to as two-component technology.

JP 2014-105250 A discloses a urethane prepolymer composition containing a hydroxyl-containing urethane prepolymer produced from 20-80% by weight of a hydroxyl-terminated urethane prepolymer and 20-80% by weight of an oligomer free from urethane groups. The composition may be made into artificial leather with appropriate crosslinkers as a constituent of a two-component system.

CN 102758359 A discloses a process for producing a polyurethane foam coating based on two-component systems, wherein initially a lower foam layer made of a polyurethane component A (a polyol or polyamine) and a polyurethane component B (a diisocyanate-based isocyanate monomer or a prepolymer of an isocyanate and polyol) is produced and subsequently top-coated with a water-based polyurethane composition containing a water-based polyurethane and a crosslinker (an aliphatic epoxy resin or a polyisocyanate). The polyurethane foam coating may be used as a synthetic leather.

JP 2006-316127 A discloses a curable solvent-free urethane resin composition containing a compound having active hydrogen atoms and a polyisocyanate, wherein the latter is an adduct of a glycol and a diisocyanate. The composition may be used to produce artificial leather.

EP 3 514 189 A1 discloses a two-component system suitable for producing artificial leather. The polyol component is based on a reaction product of a diisocyanate and isocyanurate with a polyol component.

Since two-component systems have the disadvantage of reacting rapidly, the two components must be stored separately. In some cases the curing occurring in the plant may also be unwanted. For this reason one-component systems were developed where the isocyanate groups of the polyurethane prepolymer are blocked in a chemically reversible manner to avoid reaction at room temperature as soon as the crosslinker is added. Blocking of the isocyanate groups with oximes or lactams is customary in the prior art.

Thus, J P 2006-070059 A discloses a polyurethane prepolymer produced from a polycarbonate diol and an organic diisocyanate which is suitable for use in one-component systems and whose isocyanate groups were subsequently blocked. The prepolymer was preferably blocked with a ketoxime or lactam.

However, disadvantages of blocking with ketoximes and lactams include inter alia that toxic byproducts are eliminated during unblocking.

The prior art teaches blocking alternative prepolymers with malonates to solve this problem.

DE 196 22 136 A1 discloses a process for blocking an isocyanate-polyol prepolymer with malonate.

DE 11 2005 001 991 T5 discloses a prepolymer based on TDI and a diol which was blocked with diethyl malonate.

U.S. Pat. No. 4,240,943 A discloses a urethane prepolymer based on hexamethylene diisocyanate and a polyesterdiol which was subsequently blocked with diethyl malonate.

WO 2014/039306 A1 discloses the production of a diethyl malonate-blocked H12MD1-polyTHF prepolymer.

EP 3 712 188 A1 discloses polyisocyanate compositions comprising at least one diisocyanate, a polyol having a number-average molecular weight of 400-5000 and an average number of hydroxy groups of 3 to 8 which may have been reacted with a blocking agent which may be malonate.

U.S. Pat. No. 5,863,983 discloses a process where (inter alia sulfonate-blocked polyols) are reacted with an isocyanate and subsequently subjected to blocking with malonate.

The prior art further teaches the reaction of malonate-blocked prepolymers with di- or polyols.

U.S. Pat. No. 4,518,522 A discloses for example prepolymers produced inter alia from polyalkylene glycols having different number-average molecular weights and different diisocyanates.

DE 25 50 156 A1 discloses mixtures of blocked polyisocyanate producible from polyhydroxy compounds having a molecular weight of 62 to about 300 g and an isocyanate and subsequent blocking with diethyl malonate for example. They are employed in baked coatings and reacted with compounds having at least two isocyanate-reactive hydrogen atoms and a molecular weight of about 400 to about 50 000 g/mol.

EP 3 689 936 A1 discloses coating materials which may comprise a blocked polyisocyanate and a polyhydroxy compound. The blocked polyisocyanate may have urethane units formed by reaction with a hydrophilic compound. The hydrophilic compound may be polyether polyols based on ethylene oxide which preferably comprise not more than 30 ethylene oxide units.

EP 53 766 A1 discloses compositions comprising prepolymers of isocyanates and polyols which are blocked with malonates and cured with polyols. The systems described therein are used to produce coatings. Curing with amines is presented as disadvantageous therein. The prior art further describes the curing of malonate-blocked prepolymers with amines. Curing with amines has the advantage of being performable more quickly and/or without catalyst. Furthermore, the typical di- and polyols suitable for curing have the disadvantage of being hygroscopic.

EP 3 348 593 A1 discloses blocked polyisocyanates derived from a diisocyanate and a malonic ester. The polyisocyanate may be produced by reaction of a diisocyanate with a di- to hexahydric alcohol (for example trimethylolpropane). The description discloses the use of the blocked polyisocyanates in 1K compositions which may also comprise a polyamine.

U.S. Pat. No. 5,071,937 A discloses coating compositions comprising a malonate-blocked isocyanate prepolymer of an isocyanate and a polyol having a molecular weight of 400-10 000 g/mol and a sterically hindered aromatic polyamine. It also discloses their use together with the polyols used for their production for producing coating compositions employable for different applications. However, the use of aromatic amines is disadvantageous not only having regard to potential health hazards but also due to resulting disadvantageous properties of the coatings.

The prior art further discloses the curing of malonate-blocked prepolymers based on polyethers and isocyanates with amines.

U.S. Pat. Nos. 4,439,593 A and 4,677,180 A disclose coating compositions comprising a malonate-blocked prepolymer of an isocyanate and a polyol. The polyol is a compound having a number-average molecular weight of 100-10 000 g/mol, preferably 400-8000 g/mol or 800-8000 g/mol. The compound is preferably a polyether. The coating composition may further contain a diamine and be employed for various applications. Employable amines include inter alia isophoronediamine and 4,4′-diaminodicyclohexylmethane.

EP 0 034 272 discloses a process for producing fabrics having a velour-like surface which employs a coating paste comprising a blocked NCO prepolymer and a polyamine. The NCO prepolymers may be produced from hydroxyl-containing compounds having a molecular weight of 500-10 000, preferably 1000-6000 and various diisocyanates. It is preferable to employ polypropylene oxide polyethers having an average molecular weight of 1000-6000 g/mol. The blocking may also be effected inter alia with malonic esters but butanone oxime is preferred.

WO 2017/107064 A1 discloses a composition suitable for producing or coating inter alia leather articles which comprises at least one blocked isocyanate-terminated prepolymer (produced from a polyol component and an isocyanate component) and at least one polyamine. The polyol component preferably has a number-average molecular weight of 2000-8000 g/mol, more preferably 2500-7000 g/mol and very particularly preferably 3000-6500 g/mol. It may be a polyether polyol. The isocyanate component may be an aliphatic or aromatic polyisocyanate. The prepolymer may inter alia be blocked with malonate.

However, the 1K compositions described in the prior art do not allow production of artificial leather and (artificial) leather coatings having sufficiently good properties. The prior art 1K compositions especially cannot achieve sufficiently good tensile strengths and elongation values in conjunction with good elastic modulus values. Desirable properties are in particular tensile strengths of 17-23 N/mm 2, elongation values of 600-900% by weight and elastic modulus values of 2-4.5 MPa at 100%, 4-7 MPA at 200% and 5.5-10 MPa at 300% (all values measured according to DIN EN ISO 527).

It is accordingly an object of the present invention to avoid the disadvantages of the prior art. It is especially an object of the present invention to provide one-component compositions which do not eliminate toxic byproducts during curing and which may be used to produce artificial leather and (artificial) leather coatings having good properties, in particular in respect of the abovementioned parameters such as tensile strength, elongation and elastic moduli.

This object is achieved by the one-component system according to the invention comprising
a) at least one polyurethane prepolymer based on at least one di- and/or polyisocyanate and at least one di- and/or polyol, wherein at least one di- or polyol is a polyalkylene glycol having a number-average molecular weight of 900-2150 g/mol, wherein all unconverted isocyanate groups of the polyurethane prepolymer are blocked with at least one malonic ester and
b) at least one di- and/or polyamine.

a) Polyurethane Prepolymer

A polyurethane prepolymer “based on” at least one di- and/or polyisocyanate and at least one di- and/or polyol is to be understood as meaning an oligomeric or polymeric isocyanate-terminated reaction product producible from a deficit of at least one diol and/or at least one polyol and an excess of at least one diisocyanate and/or at least one polyisocyanate and having at least two urethane bonds (formed by reaction of a respective hydroxy group of the at least one di- or polyol and a respective isocyanate group of the di- or polyisocyanate), whose unreacted terminal isocyanate groups were subsequently blocked. The blocking of the unconverted isocyanate group(s) with the at least one malonic ester is carried out via bonding of the CH-acidic, α-carbon atom of the malonic ester to the electrophilic carbon atom of the isocyanate group(s).

Di-/Polyisocyanate

The prepolymer is in principle based on one or more di- and/or polyisocyanates. However, particularly good properties are achieved when it is based on one di- or polyisocyanate. The term “polyisocyanate” is to be understood as meaning compounds having at least three isocyanate groups.

The prepolymer may in principle be based on at least one di- and/or polyisocyanate. However, particularly good properties are achieved with at least one diisocyanate or at least one polyisocyanate. The prepolymer is more preferably based on one diisocyanate or one polyisocyanate. It is yet more preferably based on one diisocyanate.

The prepolymer is preferably based on at least one (cyclo)aliphatic diisocyanate, i.e. at least one diisocyanate having cyclically and/or aliphatically bonded isocyanate groups. The prepolymer is yet more preferably based on a (cyclo)aliphatic diisocyanate. Systems based on aromatic compounds (i.e. not (cyclo)aliphatic compounds) result in disadvantageous properties, especially in respect of yellowing.

It is more preferable when the at least one diisocyanate is selected from HDI (hexamethylene diisocyanate), TMDI (a mixture of 2,2,4- and 2,4,4-trimethylhexamethylene diisocyanate), H12MD1 (4,4′-methylene-bis-(cyclohexyl isocyanate)), IPDI (isophorone diisocyanate), TMXDI (o-tetramethylxylylene diisocyanate, m-tetramethylxylylene diisocyanate, p-tetramethylxylylene diisocyanate or mixtures thereof), XDI (o-xylylene diisocyanate, m-xylylene diisocyanate, p-xylylene diisocyanate or mixtures thereof), MDI (2,2′-diphenylmethane diisocyanate, 2,4′-diphenylmethane diisocyanate, 4,4′-diphenylmethane diisocyanate or mixtures thereof), TDI (2,4-toluene diisocyanate) and it is yet more preferable when the at least one diisocyanate is selected from HDI, TMDI, H12MDI and IPDI. Particularly good results are achieved when the one diisocyanate is selected from HDI, TMDI, H12MDI, IPDI, TMXDI, XDI, MDI and TDI. Especially good results are achieved when the one diisocyanate is selected from HDI, TMDI, H12MDI and IPDI (isophorone diisocyanate). The best results are achieved when the diisocyanate is IPDI.

The prepolymer may be based on at least one polyisocyanate. It is further preferable when the prepolymer is based on at least one, preferably one, diisocyanate and at least one, more preferably one, polyisocyanate. The polyisocyanate is particularly preferably a polyisocyanate derived from IPDI, HDI, H12MDI or TDI. Particularly preferred polyisocyanates are the corresponding isocyanurates, very particularly preferably the isocyanurates of IPDI and HDI.

The prepolymer is preferably based on 0-40% by weight, more preferably 0-30% by weight, yet more preferably 0-20% by weight, of polyisocyanate based on the total mass of di- and polyisocyanate.

Di-/Polyol

The prepolymer is in principle based on one diol or two or more diols and/or one polyol or two or more polyols. However, particularly good properties are achieved when it is based on one di- or polyol or altogether two di- or polyols. The term “polyol” is to be understood as meaning compounds having at least three hydroxy groups. Particularly good properties are achieved with at least one diol. It is more preferable when the prepolymer is based on one or two, more preferably two, diols. It is yet more preferable when it is based on 80-100% by weight of a first diol and 0-20% by weight of a second diol, wherein the reported weights are based on the total mass of diols. The prepolymer is very particularly preferably based on two diols. It is yet more preferable when it is based on 80-99% by weight, yet more preferably 80-95% by weight, of a first diol and 0.1-20% by weight, yet more preferably 5-20% by weight, of a second diol, wherein the reported weights are based on the total mass of diols.

According to the invention at least one di- and/or polyol is a polyalkylene glycol having a number-average molecular weight of 900 to 2150 g/mol, wherein the number-average molecular weight is determined by GPC according to DIN EN ISO 13885-1 using THF as eluent. If only one di- and/or polyol is employed, the prepolymer is thus based exclusively on the polyalkylene glycol having a number-average molecular weight of 900 to 2150 g/mol as the di/polyol.

If more than one di- or polyol is employed, the proportion of the polyalkylene glycol, based on the total mass of other di- and/or polyols present, during production of the polyurethane prepolymer is preferably at least 50% by weight, more preferably at least 60% by weight, yet more preferably at least 70% by weight. It is preferable when the polyalkylene glycol is the first diol.

Particularly good results are achieved when the polyalkylene glycol is a polytetramethylene ether glycol (polyTHF). It is yet more preferable when the first diol is a polytetramethylene ether glycol.

The best results are achieved when the polytetramethylene ether glycol has a number-average molecular weight of 950-2100 g/mol. Corresponding preferred commercial products are polyTHF1000, polyTHF1800 and polyTHF2000 (BASF). The number-average molecular weight is very particularly preferably 950-1200 g/mol. A corresponding very particularly preferred commercial product is polyTHF1000 (BASF).

If the prepolymer is based on more than only one di/polyol, production of the prepolymer employs not only the polyalkylene glycol but also at least one further, preferably a second, di- or polyol. The prepolymer is preferably based on the polyalkylene glycol and a further diol or polyol. The prepolymer is yet more preferably based on the polyalkylene glycol and a second diol.

To achieve good properties, the further or second diol is selected from the group consisting of
hydroxyl-terminated polyesterdiols, in particular adipate, succinate and phthalate diols, preferably having a number-average molecular weight of 500-3000 g/mol, particularly preferably 1000-2000 g/mol,
hydroxyl-terminated polycarbonate diols, preferably having a number-average molecular weight of 500-3000, more preferably 1000-2000 g/mol,
hydroxyl-terminated polycaprolactone diols, preferably having a number-average molecular weight of 500-3000, more preferably 1000-2000 g/mol and
hydrocarbon diols having two to ten carbon atoms.

It is very particularly preferable when the further/second diol is a hydrocarbon diol having two to ten carbon atoms. It is more preferable when the prepolymer is based on a hydrocarbon diol selected from ethylene glycol, n-propylene glycol, i-propane glycol, 2-methyl-1,3-propanediol, n-butylene glycol and n-pentyl glycol, n-hexanediol, diethylene glycol, 1,4-cyclohexanedimethanol, tripropylene glycol and 1,10-decanediol. It is yet more preferable when the prepolymer is based on a hydrocarbon diol selected from ethylene glycol, n-propylene glycol, i-propane glycol, 2-methyl-1,3-propanediol, n-butylene glycol and n-pentyl glycol, n-hexanediol. The prepolymer is particularly preferably based on n-butylene glycol.

The prepolymer is particularly preferably based on a polytetramethylene ether glycol having a number-average molecular weight of 950-1200 g/mol and n-butylene glycol.

Malonic Ester

Since a deficit of di- or polyol is employed in the production of the polyurethane prepolymer, the resulting intermediate has unconverted isocyanate groups. These were blocked with at least one malonic ester in the production of the polyurethane prepolymer. The previously free isocyanate radicals may be blocked both with monoalkyl malonates and with dialkyl malonates. Blocking is preferably effected with a malonic ester. Blocking is yet more preferably effected with a malonic ester selected from dimethyl malonate, diethyl malonate, diisopropyl malonate and monoethyl malonate. It is very particularly preferable when blocking is effected with diethyl malonate.

Process for producing the prepolymer Production of the polyurethane prepolymer present in the one-component system is described below. This comprises a) reacting at least one di- and/or polyol with at least one di- and/or polyisocyanate in excess and subsequently b) blocking unconverted isocyanate groups with at least one malonic ester.

One or more di- and/or polyisocyanates may in principle be employed. However, particularly good properties are achieved when one di- or polyisocyanate is employed. The term “polyisocyanate” is to be understood as meaning compounds having at least three isocyanate groups.

At least one di- and/or polyisocyanate may in principle be employed. However, particularly good properties are achieved with at least one diisocyanate or at least one polyisocyanate. It is yet more preferable to employ one diisocyanate or polyisocyanate. It is yet more preferable to employ a diisocyanate.

It is very particularly preferable to employ at least one (cyclo)aliphatic diisocyanate, i.e. at least one diisocyanate having cyclically and/or aliphatically bonded isocyanate groups. It is yet more preferable to employ a (cyclo)aliphatic diisocyanate. Polymers based on aromatic compounds have disadvantageous properties, in particular in respect of yellowing in their subsequent use.

It is more preferable when the at least one diisocyanate is selected from HDI (hexamethylene diisocyanate), TMDI (a mixture of 2,2,4- and 2,4,4-trimethylhexamethylene diisocyanate), H12MDI (4,4′-methylene-bis-(cyclohexyl isocyanate)), IPDI (isophorone diisocyanate), TMXDI (o-tetramethylxylylene diisocyanate, m-tetramethylxylylene diisocyanate, p-tetramethylxylylene diisocyanate or mixtures thereof), XDI (o-xylylene diisocyanate, m-xylylene diisocyanate, p-xylylene diisocyanate or mixtures thereof), MDI (2,2′-diphenylmethane diisocyanate, 2,4′-diphenylmethane diisocyanate, 4,4′-diphenylmethane diisocyanate or mixtures thereof), TDI (2,4-toluene diisocyanate). It is yet more preferable when the at least one diisocyanate is selected from HDI, TMDI, H12MDI and IPDI. Particularly good results are achieved when the one diisocyanate is selected from HDI, TMDI, H12MDI, IPDI, TMXDI, XDI, MDI and TDI. Very particularly good results are achieved when the one diisocyanate is selected from HDI, TMDI, HMDI and IPDI. The best results are achieved when the diisocyanate is IPDI.

The process may also employ at least one polyisocyanate. It is more preferable when the process according to the invention employs at least one, preferably one, diisocyanate and at least one, more preferably one, polyisocyanate. It is particularly preferable to employ a polyisocyanate derived from IPDI, HDI, H12MDI or TDI. Particularly preferred polyisocyanates are the corresponding isocyanurates, very particularly preferably the isocyanurates of IPDI and HDI.

The process preferably employs 0-40% by weight, more preferably 0-30% by weight, yet more preferably 0-20% by weight, of polyisocyanate based on the total mass of di- and polyisocyanate.

In addition to the at least one di- and/or polyisocyanate, the process employs at least one or more diols and/or one or more polyols. However, particularly good properties are achieved when a di- or polyol or altogether two diols/polyols or a mixture of a diol and a polyol is employed. The term “polyol” is to be understood as meaning compounds having at least three hydroxy groups. Particularly good properties are achieved with at least one diol. It is more preferable to employ 1 to 2 diols. It is very particularly preferable to employ two diols. It is yet more preferable to employ 80-100% by weight of a first diol and 0-20% by weight of a second diol, wherein the reported weights are based on the total mass of diols. The prepolymer is very particularly preferably based on two diols. It is yet more preferable to employ 80-99.9% by weight, yet more preferably 80-95% by weight, of a first diol and 0.1-20% by weight, yet more preferably 5-20% by weight, of a second diol, wherein the reported weights are based on the total mass of diols.

At least one di- and/or polyol is a polyalkylene glycol having a number-average molecular weight of 900 to 2150 g/mol, wherein the number-average molecular weight is determined by GPC according to DIN EN ISO 13885-1 using THF as eluent.

If more than one di- or polyol is employed the proportion of the polyalkylene glycol, based on the total mass of other di- and/or polyols present, during production of the polyurethane prepolymer is preferably at least 50% by weight, more preferably at least 60% by weight, yet more preferably at least 70% by weight.

Particularly good results are achieved when the polyalkylene glycol is a polytetramethylene ether glycol (polyTHF). Polytetramethylene ether glycol is yet more preferable.

The best results are achieved when the polytetramethylene ether glycol has a number-average molecular weight of 950-2100 g/mol. Corresponding preferred commercial products are polyTHF1000, polyTHF1800 and polyTHF2000 (BASF). The number-average molecular weight is very particularly preferably 950-1200 g/mol. A corresponding very particularly preferred commercial product is polyTHF1000 (BASF).

Production of prepolymer based on more than only one di/polyol employs not only the polyalkylene glycol but also at least one further or second di- or polyol, preferably a further or second diol.

To achieve good properties of the resulting prepolymers, the further or second diol is selected from the group consisting of
hydroxyl-terminated polyesterdiols, in particular adipate, succinate and phthalate diols, preferably having a number-average molecular weight of 500-3000 g/mol, particularly preferably 1000-2000 g/mol,
hydroxyl-terminated polycarbonate diols, preferably having a number-average molecular weight of 500-3000, more preferably 1000-2000 g/mol,
hydroxyl-terminated polycaprolactone diols, preferably having a number-average molecular weight of 500-3000, more preferably 1000-2000 g/mol,
hydrocarbon diols having two to ten carbon atoms.

The process particularly preferably employs a hydrocarbon diol having two to ten carbon atoms as a further/second diol.

It is more preferable to employ a hydrocarbon diol selected from ethylene glycol, n-propylene glycol, i-propane glycol, 2-methyl-1,3-propanediol, n-butylene glycol and n-pentyl glycol, n-hexanediol, diethylene glycol, 1,4-cyclohexanedimethanol, tripropylene glycol and 1,10-decanediol. It is yet more preferable to employ a hydrocarbon diol selected from ethylene glycol, n-propylene glycol, i-propane glycol, 2-methyl-1,3-propanediol, n-butylene glycol and n-pentyl glycol, n-hexanediol. Particular preference is given to using n-butylene glycol.

The process particularly preferably employs two diols, namely a polytetramethylene ether glycol having a number-average molecular weight of 800-1200 g/mol and n-butylene glycol.

Reaction step a) may preferably be performed in the absence of a solvent and at a temperature of preferably 50-70° C. It is more preferable when reaction step a) is performed in the presence of a catalyst since this makes it possible to achieve faster reaction times and lower viscosities. Preferred catalysts may be selected from the group consisting of optionally alkyl-substituted tin, zinc and bismuth salts of organic acids. Very particularly preferred salts are the optionally alkyl-substituted acetates, laurates and stearates of tin, zinc and bismuth. It is very particularly preferable to perform reaction step a) of the process according to the invention with dibutyltin dilaurate or zinc octoate.

Production of the polyurethane prepolymer employs di- or polyisocyanate in excess. The resulting intermediate accordingly comprises unconverted isocyanate groups. These are then blocked with at least one malonic ester in reaction step b). The previously free isocyanate radicals may be blocked both with monoalkyl malonates and with dialkyl malonates. Blocking is preferably effected with a malonic ester. Blocking is yet more preferably effected with a malonic ester selected from dimethyl malonate, diethyl malonate, diisopropyl malonate and monoethyl malonate. It is very particularly preferable when blocking is effected with diethyl malonate.

Reaction step b) may preferably be performed in the absence of a solvent and at a temperature of preferably 70-90° C. It is more preferable to perform reaction step b) in the presence of a catalyst. Preferred catalysts may be selected from the group consisting of optionally alkyl-substituted tin, zinc and bismuth salts of organic acids. Very particularly preferred salts are the optionally alkyl-substituted acetates, laurates, stearates, octoates, neodecanoates, acetoacetates, oxalates, adipates and gluconates of tin, zinc and bismuth. It is very particularly preferable to perform reaction step a) of the process according to the invention with dibutyltin dilaurate or zinc octoate.

The catalysts employed in steps a) and b) may be identical or different. Steps a) and b) preferably employ the same catalyst.

The catalyst amount is preferably 0.1-10%, preferably 0.1-7%, based on the total mass of all components.

The reaction in step a) is very particularly preferably carried out at temperatures of 50-70° C. over one hour. The reaction in step b) is very particularly preferably carried out such that the malonic ester is added at 70-90° C. over a window of up to one hour. Typical reaction times are 5-10 h.

It is particularly preferable when the process according to the invention comprises reacting a mixture consisting of
5-50% by weight of IPDI, H12MDI, TMDI or HDI,
0-30% by weight of polyisocyanurate selected from IPDI, H12MDI, TMDI or HDI,
5-90% by weight of polytetramethylene ether glycol having a number-average molecular weight of 1000, 1800 or 2000 g/mol (corresponding to the commercial products PolyTHF 100, PolyTHF1800 and PolyTHF2000),
0-50% by weight of butanediol and
0.1-10% by weight of zinc octoate

in step a). Reported percentages here relate to the total mass of the composition. Subsequently, preferably

5-50% by weight of diethyl malonate (based on the total mass of composition and diethyl malonate) may be added and step b) performed.

It is very particularly preferable when the process according to the invention comprises reacting a mixture consisting of
10-30% by weight of IPDI, H12MDI, TMDI or HDI,
0-5% by weight of polyisocyanurate selected from IPDI, H12MDI, TMDI or HDI,
20-80% by weight of polytetramethylene ether glycol having a number-average molecular weight of 1000, 1800 or 2000 g/mol,
0-20% by weight of butanediol and
0.1-7% by weight of zinc octoate

in step a). Reported percentages here relate to the total mass of the composition. Subsequently, preferably
5-25% by weight of diethyl malonate (based on total mass of composition and diethyl malonate) may be added and step b) performed.

It is yet more preferable when the process according to the invention comprises reacting a mixture consisting of
10-30% by weight of IPDI, H12MDI, TMDI or HDI,
1-5% by weight of polyisocyanurate selected from IPDI, H12MDI, TMDI or HDI,
20-80% by weight of polytetramethylene ether glycol having a number-average molecular weight of 1000, 1800 or 2000 g/mol,
0-20% by weight of butanediol and
0.1-7% by weight of zinc octoate

in step a). Reported percentages here relate to the total mass of the composition. Subsequently, preferably
5-25% by weight of diethyl malonate (based on total mass of composition and diethyl malonate) may be added and step b) performed.

The present invention accordingly also provides a kit which comprises a prepolymer obtainable by any of the above-described processes.

b) Di/Polyamine

The one-component system comprises at least one diamine and/or polyamine. Diamines have two amino groups. Polyamines have three or more amino groups. It preferably comprises at least one diamine. It very particular preferably comprises one diamine. It is yet more preferable when the diamine is a (cyclo)aliphatic amine or a polyetheramine.

The diamine is preferably selected from isophorondiamine (IPD), 4,4′-diaminodicyclohexylmethane (PACM), 4,4′-methylenebis(2-methylcyclohexanamine) (DMDC), a mixture of 2,2,4- and 2,4,4-trimethylhexamethylenediamine (TMD), hexanediamine (HDA), 1,3-bis(aminomethyl)cyclohexane (1,3-BAC) and a polyoxypropylenediamine. The polyoxypropylene diamine is preferably a polyoxypropylene diamine referred to as D-230. The diamine may thus preferably be selected from the group consisting of isophorondiamine (IPD), 4,4′-diaminodicyclohexylmethane (PACM), 4,4′-methylenebis(2-methylcyclohexanamine) (DMDC), a mixture of 2,2,4- and 2,4,4-trimethylhexamethylenediamine (TMD), hexanediamine (HDA), 1,3-bis(aminomethyl)cyclohexane (1,3-BAC) and a polyoxypropylenediamine referred to as D-230.

The present invention further relates to a process for producing the one-component system which comprises mixing at least one polyurethane prepolymer based on a polyalkylene glycol having a number-average molecular weight of 900 to 2150 g/mol and optionally further di- and/or polyols, wherein all unconverted isocyanate groups of the polyurethane prepolymer are blocked with at least one malonic ester, and at least one di- and/or polyamine.

The present invention further provides for the use of the polyurethane prepolymer according to the invention for producing artificial leathers or (artificial) leather coatings.

The present invention further provides a process for producing an artificial leather or an (artificial) leather coating which employs the one-component system according to the invention. The process particularly preferably employs a one-component system containing precisely one diamine or polyamine. It is very particularly preferable to employ a system containing one diamine. It is very particularly preferable to employ a system containing one polyurethane prepolymer and one diamine.

The process for producing an artificial leather is preferably performed such that the one-component system is applied to a carrier and thermally cured. An embossing step for surface configuration may also be provided during or after the thermal curing. The carrier is preferably a fibrous carrier, preferably a carrier comprising natural or artificial fibers. The carrier is more preferably paper, cotton or polyester.

The process for producing an (artificial) leather coating is preferably performed such that the one-component system is applied to a piece of artificial leather or leather and thermally cured. An embossing step for surface configuration may also be provided during or after the thermal curing.

Since the polyurethane prepolymer does not react with the at least one diamine and/or polyamine in the one-component system at room temperature, the system may be stored.

### EXAMPLES

1. Production of the Prepolymer

The prepolymer of isophorone diisocyanate and polyTHF is initially produced with the employed weights reported in table 1 by reaction in the presence of 0.1% by weight of DBTL at 60° C. over one hour.

The diisocyanate prepolymer is subsequently produced with the employed weights of diethyl malonate (inventive examples) or caprolactam/MEK oxime (comparative examples) reported in table 1 by reaction in the presence of 2.0% by weight of zinc octoate at 80° C. over 8 h.

2. Artificial Leather Production

To produce an (artificial) leather coating, the obtained blocked prepolymer is mixed with a diamine (PACM/isophoronediamine) and further components with the employed weights reported in table 1 in a laboratory mixing apparatus at a temperature of 40° C. and a mixing speed of 1200 rpm.

The composition is applied to a release substrate with a film applicator and cured at a temperature of 120° C. to 150° C. to afford the (artificial) leather coating.

The test results for the obtained coatings are summarized in table 2. Only malonate-blocked prepolymers result in optimal coatings having regard to the achieved values for tensile strength, elongation and elastic modulus.

TABLE 1

| % by wt. | 1 | 2 | 3 | 4 | 5* | 6* | 7* | 8* | 9* |
|---|---|---|---|---|---|---|---|---|---|
| IPDI | 22.2 | 22.1 | 21.9 | 21.8 | 27.2 | 11.4 | 22.4 | 24.1 | 23.8 |
| PolyTHF 1000 | 48.7 | 48.4 | 48.0 | 47.0 | 37.8 | — | 54.8 | 52.8 | 52.1 |
| PolyTHF 650 | — | — | — | — | — | — | — | — | — |
| PolyTHF 3000 | — | — | — | — | — | 73.1 | — | — | — |
| PACM | 10.3 | 10.3 | 10.3 | — | 12.6 | 5 | 11.4 | 12.8 | 12.3 |
| IPDA | — | — | — | 12.3 | — | — | — | — | — |
| Diethyl malonate | 16.4 | 16.6 | 16.3 | 16.6 | 20.1 | 8 | — | — | — |
| MEK oxime | — | — | — | — | — | — | — | 9.8 | 9.6 |
| ε-Caprolactam | — | — | — | — | — | — | 11.3 | — | — |
| TIB Kat 218 | 0.1 | 0.1 | — | 0.1 | 0.1 | 0.1 | 0.1 | 0.1 | 0.1 |
| Coscat 83 | — | — | 0.1 | — | — | — | — | — | — |
| BorchiKat 22 | 1.8 | 1.8 | — | 1.7 | 1.7 | 1.9 | — | — | 1.7 |
| BorchiKat 0761 | — | — | 2.7 | — | — | — | — | — | — |
| Acetylacetone | — | 0.3 | 0.25 | — | — | — | — | — | — |
| Tegoglide B1484 | 0.5 | 0.5 | 0.5 | 0.5 | 0.5 | 0.5 | — | 0.5 | 0.5 |

*= noninventive comparative examples
IPDI: Isophorone diisocyanate, Evonik Industries AG
PolyTHF 1000: PolyTHF (molar mass 1000 g/mol), BASF
PolyTHF 650: PolyTHF (molar mass 650 g/mol), BASF
PolyTHF 3000: PolyTHF (molar mass 3000 g/mol), BASF
PACM: 4,4′-Diaminodicyclohexylmethane, Evonik Industries AG
IPDA: Isophoronediamine, Evonik Industries AG
Diethyl malonate: Merck
MEK oxime and acetylacetone: Merck
ε-Caprolactam BASF
TIB Kat 218: TIB Chemicals
Coscat 83: Erbslöh
Borchikat 22 and 0761: Borchers
Tegoglide B1484: Evonik Industries AG

TABLE 2

| Measured | | | | | | | | | | |
|---|---|---|---|---|---|---|---|---|---|---|
| parameters | Unit | 1 | 2 | 3 | 4 | 5 | 6 | 7* | 8* | 9* |
| Film thickness | μm | 173 | 144 | 180 | 166 | 167 | 146 | 377 | 246 | 158 |
| Tensile strength | N/mm² | 20.4 | 19.7 | 21.1 | 21.3 | 20.4 | 16.1 | 3.1 | 36.1 | 30.7 |
| Elongation | % | 879 | 751 | 884 | 593 | 409 | 1900 | 206 | 863 | 792 |
| Elastic modulus | Mpa | 2.7 | 2.8 | 2.8 | 4.4 | 7.3 | 0.7 | 2.5 | 7.6 | 7.6 |
| 100% | | | | | | | | | | |
| Elastic modulus | Mpa | 4.2 | 4.6 | 4.1 | 6.5 | 11.1 | 1.1 | 3.2 | 9.7 | 9.6 |
| 200% | | | | | | | | | | |
| Elastic modulus | Mpa | 5.7 | 6.4 | 5.4 | 9.1 | 15.6 | 1.3 | 0.0 | 12.4 | 12.1 |
| 300% | | | | | | | | | | |

Methods of Measurement:

Film thickness: DIN EN ISO 2360

Tensile strength, elongation, elastic modulus 100%, elastic modulus 200%, elastic modulus 300%: DIN EN ISO 527

What is claimed is:

1. A one-component system comprising
a) at least one polyurethane prepolymer based on at least one di- and/or polyisocyanate and at least one di- and/or polyol,
wherein at least one di- or polyol is a polyalkylene glycol having a number-average molecular weight of 900 to 2150 g/mol, wherein all unconverted isocyanate groups are blocked with at least one malonic ester, and
b) at least one di- and/or polyamine.

2. The one-component system according to claim 1, wherein the prepolymer is based on a diisocyanate.

3. The one-component system according to claim 2, wherein the diisocyanate comprises a (cyclo)aliphatic diisocyanate.

4. The one-component system according to claim 2, wherein the diisocyanate is selected from HDI, TMDI, H12MDI, IPDI, TMXDI, XDI, MDI and TDI.

5. The one-component system according to claim 4, wherein the diisocyanate comprises IPDI.

6. The one-component system according to claim 1, wherein the prepolymer is based on one or two diols.

7. The one-component system according to claim 6, wherein the prepolymer is based on 80-100% by weight of a first diol and 0-20% by weight of a second diol, wherein the % by weights are based on the total mass of diols.

8. The one-component system according to claim 1, wherein the polyalkylene glycol is a polytetramethylene ether glycol.

9. The one-component system according to claim 8, wherein the number-average molecular weight of the polytetramethylene ether glycol is 950-1200 g/mol.

10. The one-component system according to claim 7, wherein the second diol is a hydrocarbon diol having two to ten carbon atoms.

11. The one-component system according to claim 10, wherein the hydrocarbon diol is selected from the group consisting of ethylene glycol, n-propylene glycol, i-propane glycol, 2-methyl-1,3-propanediol, n-butylene glycol, n-pentyl glycol, n-hexanediol, diethylene glycol, 1,4-cyclohexanedimethanol, tripropylene glycol and 1,10-decanediol.

12. The one-component system according to claim 1, wherein the at least one malonic ester is selected from dimethyl malonate, diethyl malonate, diisopropyl malonate and monoethyl malonate.

13. The one-component system according to claim 12, wherein the malonic ester is diethyl malonate.

14. The one-component system according to claim 1, wherein the di-/polyamine is a diamine selected from the group consisting of isophorondiamine, 4,4′-diaminodicyclohexylmethane, 4,4′-methylenebis(2-methylcyclohexanamine), a mixture of 2,2,4- and 2,4,4-trimethylhexamethylenediamine, hexanediamine, 1,3-bis(aminomethyl)cyclohexane and a polyoxypropylenediamine.

15. The use of a one-component system according to claim 1 for producing artificial leathers or (artificial) leather coatings.

16. A process for producing a one-component system according to claim 1, the process comprising mixing at least one polyurethane prepolymer based on a polyalkylene glycol having a number-average molecular weight of 900 to 2150 g/mol, wherein all unconverted isocyanate groups of the polyurethane prepolymer are blocked with at least one malonic ester, and at least one di- and/or polyamine.

17. A process for producing an artificial leather, wherein the one-component system according to claim 1 is applied to a carrier and thermally cured.

18. A process for producing an artificial leather coating, wherein the one-component system according to claim 1 is applied to a piece of artificial leather or leather and thermally cured.
